(19) United States
(12) Patent Application Publication
(10) Pub. No.: US 2008/0250154 A1
(43) Pub. Date: Oct. 9, 2008

(54) Self-Adaptive Multicast File Transfer Protocol

(76) Inventors: Yuanhao Sun, Shanghai (CN); Rui Jian, Shanghai (CN); Caidong Song, Shanghai (CN); Ying'an Deng, Shanghai (CN); Zhi Wang, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/574,319

(22) PCT Filed: Mar. 7, 2005
(86) PCT No.: PCT/CN2005/000264

§ 371 Date: Mar. 31, 2006

(51) Int. Cl. G06F 13/42; G06F 15/16

(52) U.S. Cl. 709/232

(57) ABSTRACT

Self-adaptive multicast and reliable transfer of digital files from a server device to one or more client devices including an active client device, one or more passive client devices and one or more smart client devices.

### TECHNICAL FIELD

Embodiments of the invention relate to multicast transfer of data from a server device to multiple client devices. More particularly, embodiments of the invention relate to use of multicast file transfer protocols in a coordinated manner.

### BACKGROUND

Currently the Trivial File Transfer Protocol (TFTP) may be used to transfer files between devices. In general, TFTP is a transfer protocol that is simpler to use than the File Transfer Protocol (FTP), but provides less functionality. For example, TFTP does not support user authentication or directory visibility. TFTP uses the User Datagram Protocol (UDP) rather than the Transmission Control Protocol (TCP). One embodiment of TFTP is described formally in Request for Comments (RFC) 1350, Rev. 2, published July 1992.

TFTP has been expanded to include a multicast option as described in RFC 2090, published February 1997. Multicast TFTP classifies client devices as active clients or passive clients. There is only one active client at a time. The active client communicates with a server to download data using a stop-and-wait ARQ flow and error control technique to a negotiated group address. Passive clients snoop on the download to the active client and capture data destined for the group address. When the active client finishes downloading the data, a passive client is selected as a new active client.

The new active client causes the complete file to be downloaded to the group address and drops duplicate data packets. Clients may drop out when all of the packets in the file have been received. Newly added clients may receive the complete file as multiple active clients download the complete file.

In an error-free network, all clients may receive the complete file by joining the group prior to initiation of the download. If, however, one or more packets are dropped and/or clients join the group after initiation of the download, the complete file download must be repeated at least once. The more error prone a network due to, for example, varying traffic patterns, the greater the number of times the complete file must be downloaded. Under extreme conditions, each passive client may become the active client to complete the download. This may result in performance that is worse than standard unicast transfer. Thus, the current state of multicast TFTP operation may result in unsatisfactory performance.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a network that may connect a server to multiple clients.

FIG. 2 is a flow diagram of one embodiment of a multicast file download to one or more active, passive and smart client devices.

FIG. 3 is a block diagram of one embodiment of an electronic system.

FIG. 4 is a state diagram of one embodiment of a role change policy for multicast file download to one or more active, passive and smart client devices.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In one embodiment of a technique described herein, only missing packets are requested for retransmission after completion of a first download to the first active client, if certain network conditions are met. In one embodiment, in addition to the active and passive clients, a smart client may be supported that manages retransmission requests. In one embodiment, a passive client tracks packet gaps within a downloaded file. Using at least the packet gap information, a passive client may transition to become a “smart client” that downloads missing data packets. In one embodiment, the smart client may actively request the lost packet numbers to the server. In one embodiment, if a packet gap is continuous, the smart client may use a protocol (e.g., TFTP) having a stream or block size option to improve throughput. By applying the techniques described herein, the retransmission time to a missing packet may be reduced and transmission performance may be improved as compared to standard multicast TFTP transfers.

In one embodiment, if the downloaded file size is unknown when the last packet is received and the size of the lost packets is under a pre-selected percentage of the total file size, the receiving passive client may be changed to a smart client. After a delay the lost packets may be requested for retransmission using a reliable protocol (e.g., TFTP). In one embodiment, if the downloaded file size is unknown and the last packet is not received, the receiving passive client may restart the downloading session. In one embodiment, if the downloaded file size is known and the size of the lost packets is under a pre-selected percentage of the total file size, the passive client may be changed to a smart client. After a delay the lost packets may be requested for retransmission using a reliable protocol (e.g., TFTP).

In one embodiment, a file may be downloaded in a pre-boot environment. The file downloaded may be, for example, a boot image, or other data used during a pre-boot phase of an electronic device.

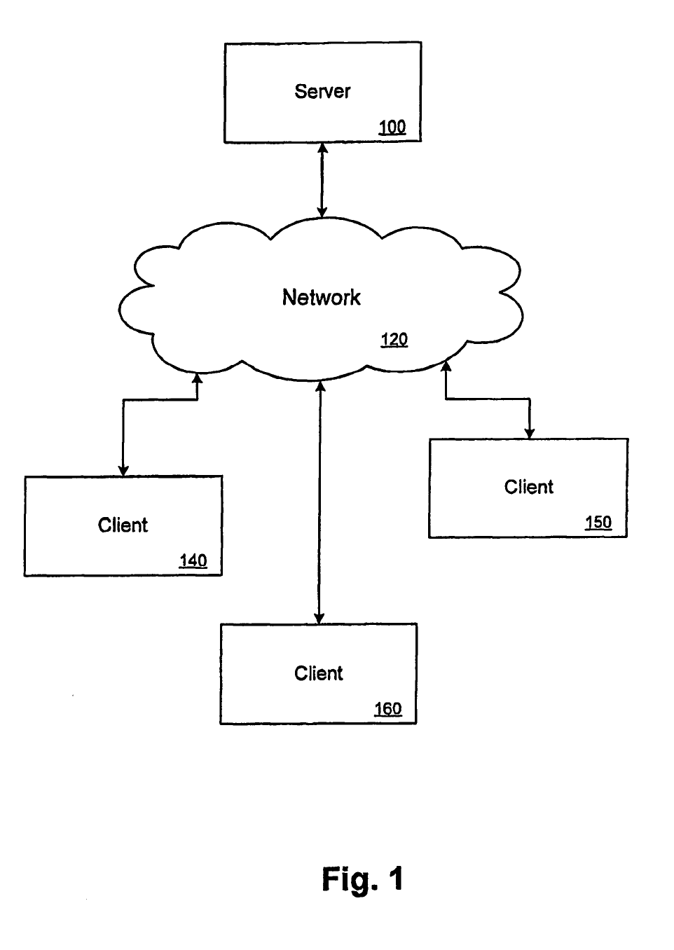

FIG. 1 is a block diagram of a network that may connect a server to multiple clients. Server 100 may be coupled with any number of clients (e.g., 140, 150, 160) via network 120, which operate according to any network communication protocol known in the art.

In one embodiment, one client, for example, client 160, may operate as an active client as defined by the multicast TFTP to request download of a file from server 100. Any number of additional clients, for example, clients 140 and 150, may operate as passive clients as defined by the multicast TFTP to receive packets corresponding to the file requested by the active client. Upon completion of the download by the active client one of the passive clients may become a smart client to download missing packets. In the description herein, the term “packet” refers to any block of data, which can be, for example, a predefined, fixed length or variable in length. In one embodiment, a packet is defined by the multicast TFTP definition. In alternate embodiments, other packet sizes may be used.

In one embodiment a passive client may join the multicast group during file download. For these passive clients, packets transmitted prior to joining the multicast group may be received when the missing packets are retransmitted to a new active client and/or a smart client.

Performance analysis using possibility theory may show that the adaptive client technique described herein may result if improved performance when packet loss caused by network conditions is considered. To simplify the description, the following assumes that all clients join the downloading session at the same time and that possibility of packet loss is uniformly distributed. In the following analysis, K is the average number of times that each packet is transmitted and T is the time for an active client to download the requested file. Thus, the time required for the passive client to download the file may be defined as:

Tₚ=K×T

Using a random variable, k, to be the exact number of times each packet is transmitted, K can be derived by assuming the probability, p, that each packet is lost or in error:

Probability[exact−k−actual]=p^{k-1}×(1−p)

From the above, random variable k is geometrically distributed.

Therefore:

$$K = {μ}_{k} = {\sum }_{k = 1}^{∞} k \times {p}^{k - 1} \times ( 1 - p ) = \frac{1}{1 - p}$$

$$and$$

$$Var [ k ] = {σ}^{2} = {\sum }_{k = 1}^{∞} {k}^{2} \times {p}^{k - 1} \times ( 1 - p ) - {μ}_{k}^{2} = \frac{p}{{( 1 - p )}^{2}}$$

Substituting into the above equation yields the average time for a passive client to download the file:

$${T}_{p} = \frac{T}{1 - p}$$

Using the adaptive client technique described herein, the time for the client to download the file is the time spent by the active client plus the time to download the missing packets. Using M to denote the number of packets in the file:

$${T}_{p}^{*} = T + p \times M \times \frac{T}{M} = ( 1 + p ) \times T$$

Therefore,

Tₚ^{•}=(1−p²)×Tₚ

Because 0≦p≦1, Tₚ^{•} is shorter than Tₚ. Under real network conditions, the probability of packet loss may not be uniformly distributed, which may improve the performance of the technique described herein.

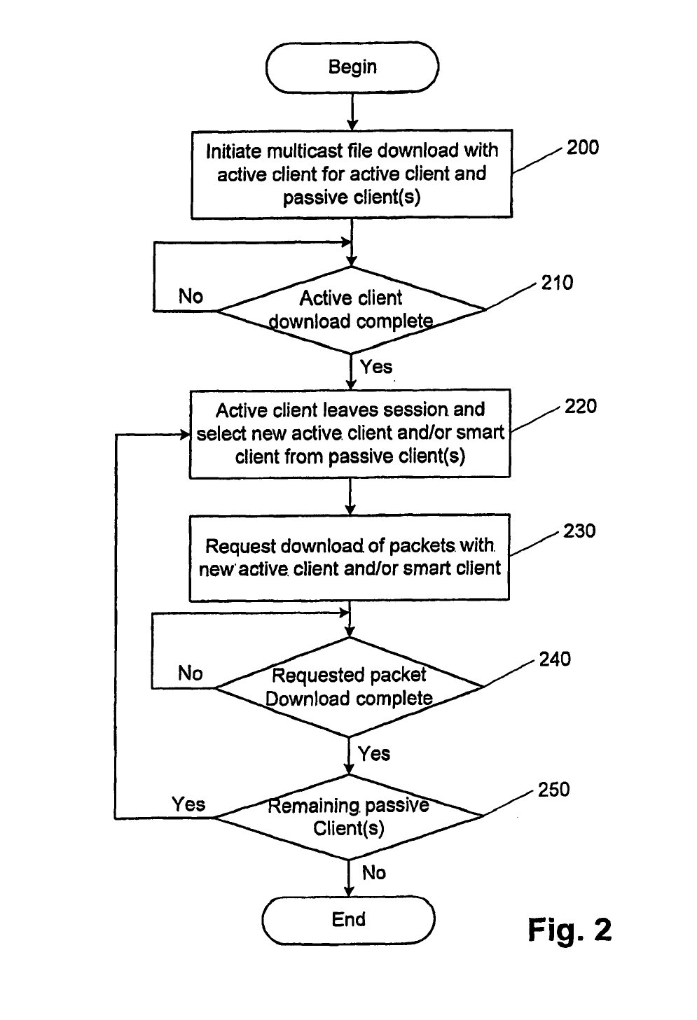

FIG. 2 is a flow diagram of one embodiment of a multicast file download to one or more active, passive and smart client devices. In the example of FIG. 2, the client devices are described as downloading a file. The file is intended to refer to any size and/or type of data that may be downloaded. The file may represent any type of data and my be blocks of data that are not traditionally considered complete files.

In one embodiment, a multicast file download session may be initiated by an active client on behalf of a group that includes the active client and one or more passive clients, 200. In one embodiment, the protocol that may be used for the multicast download is multicast TFTP. The active client may request download of the file to a group address through which the active client as well as the one or more passive clients may receive packets that carry data corresponding to the requested file.

In one embodiment, passive clients may track packet gaps within the requested file, the size of the gaps and/or the continuity of the gaps. Using this information related to the gaps and/or other information, a passive client may change state from a passive client to a smart client rather than possibly becoming an active client or remaining a passive client according to the multicast TFTP standards.

Downloading of the packets may continue until the active client completes the download of the file, 210. When the active client has completed download of the file, the active client may leave the multicast group download session and a new active client may selected according to the multicast TFTP protocol, 220. In addition to, or instead of, selecting a new active client according to the multicast TFTP protocol, one or more of the passive clients may be designated as a smart client, 220. In one embodiment, the following criteria may be used for designating a passive client as a smart client. In alternate embodiments, additional and/or different criteria may also be used. Downloading of packets may be accomplished using the multicast protocol with a new active client and/or with a non-multicast, reliable protocol with a smart client, 230.

If the passive client has successfully received all of the packets corresponding to the requested file, the passive client may leave the downloading session. If the file size is unknown and the last packet has been successfully received by the passive client and the total size of the lost packets is less than a pre-selected amount (e.g., 1 megabyte, 20% of the total file size), then the passive client may change state to become a smart client. In one embodiment, after a random delay, the smart client may request the missing packets using a reliable protocol, for example, non-multicast, or standard TFTP.

If the file size is unknown and the last packet has not been successfully received by the passive client, then the passive client may remain a passive client and continue participating in the multicast download session. If the file size is known and the total size of the lost packets is less than a pre-selected amount (e.g., 1 megabyte, 20% of the total file size), then the passive client may change state to become a smart client. In one embodiment, after a random delay, the smart client may request the missing packets using a reliable protocol, for example, non-multicast, or standard TFTP.

Downloading of the packets may continue until the new active client completes the download of the file, 240. When the new active client has completed the download, if passive clients remain, 250, the active client may leave the multicast group download session and a new active client may selected according to the multicast TFTP protocol, 220.

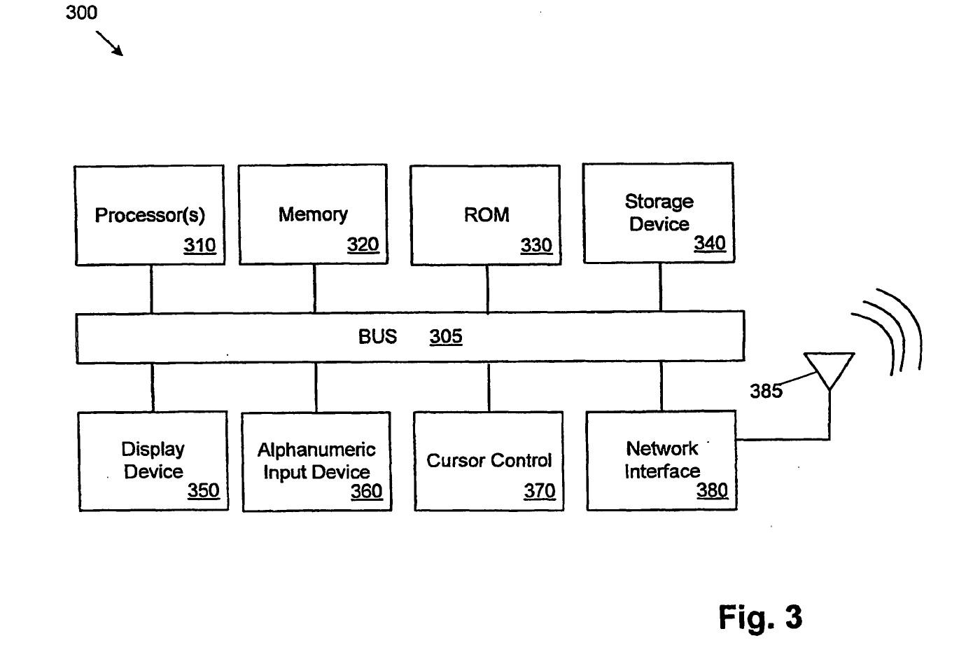

In one embodiment, the technique of FIG. 2 can be implemented as instructions executed by an electronic system. The instructions may be stored by the electronic device or the instructions can be received by the electronic device (e.g., via a network connection). FIG. 3 is a block diagram of one embodiment of an electronic system. The electronic system illustrated in FIG. 3 is intended to represent a range of electronic systems, for example, computer systems, network access devices, etc. Alternative systems, whether electronic or non-electronic, can include more, fewer and/or different components. The electronic system of FIG. 3 may represent a server device as well as the one or more client devices.

Electronic system 300 includes bus 305 or other communication device to communicate information, and processor 310 coupled to bus 305 to process information. While electronic system 300 is illustrated with a single processor, electronic system 300 can include multiple processors and/or co-processors. Electronic system 300 further includes random access memory (RAM) or other dynamic storage device 320 (referred to as memory), coupled to bus 305 to store information and instructions to be executed by processor 310. Memory 320 also can be used to store temporary variables or other intermediate information during execution of instructions by processor 310.

Electronic system 300 also includes read only memory (ROM) and/or other static storage device 330 coupled to bus 305 to store static information and instructions for processor 310. In one embodiment, static storage device 330 may include an embedded firmware agent that may have an interface compliant with an Extensible Firmware Interface (EFI) as defined by the EFI Specifications, version 1.10, published Nov. 26, 2003, available from Intel Corporation of Santa Clara, Calif. In alternate embodiments, other firmware components can also be used.

Data storage device 340 is coupled to bus 305 to store information and instructions. Data storage device 340 such as a magnetic disk or optical disc and corresponding drive can be coupled to electronic system 300.

Electronic system 300 can also be coupled via bus 305 to display device 350, such as a cathode ray tube (CRT) or liquid crystal display (LCD), to display information to a user. Alphanumeric input device 360, including alphanumeric and other keys, is typically coupled to bus 305 to communicate information and command selections to processor 310. Another type of user input device is cursor control 370, such as a mouse, a trackball, or cursor direction keys to communicate direction information and command selections to processor 310 and to control cursor movement on display 350. Electronic system 300 further includes network interface 380 to provide access to a network, such as a local area network. Network interface 380 may further include one or more antennae 385 to provide a wireless network interface according to any protocol known in the art.

Instructions are provided to memory from a storage device, such as magnetic disk, a read-only memory (ROM) integrated circuit, CD-ROM, DVD, via a remote connection (e.g., over a network via network interface 380) that is either wired or wireless providing access to one or more electronically-accessible media, etc. In alternative embodiments, hard-wired circuitry can be used in place of or in combination with software instructions. Thus, execution of sequences of instructions is not limited to any specific combination of hardware circuitry and software instructions.

An electronically-accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

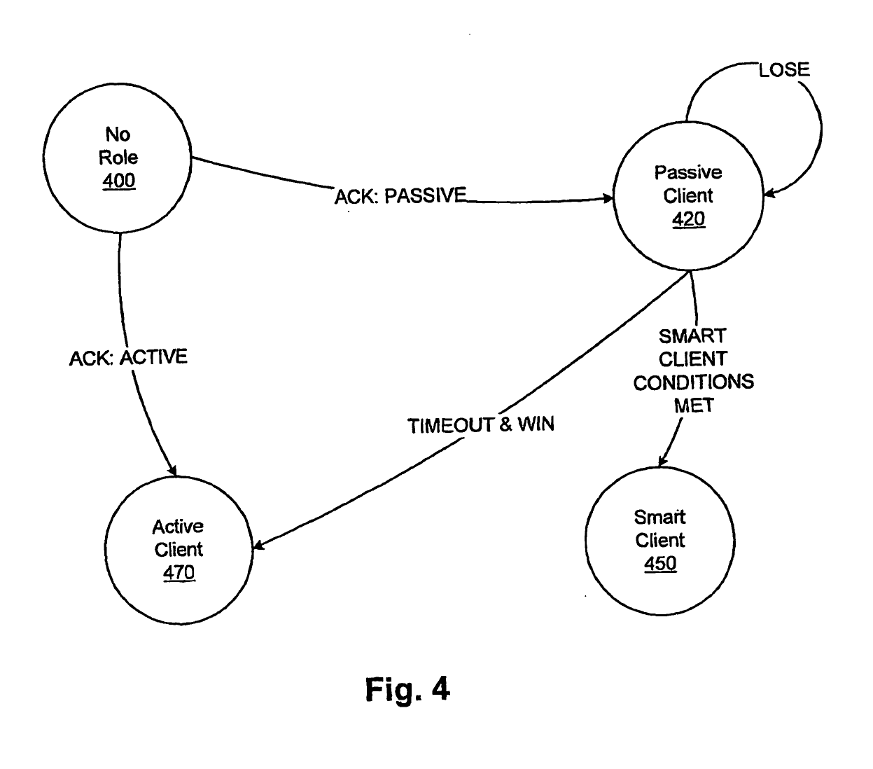

FIG. 4 is a state diagram of one embodiment of a role change policy for multicast file download to one or more active, passive and smart client devices. Initially a potential client device may have a status of “no role” 400 prior to joining the multicast download group. The potential client device may send a request message to a server or other designated device to request admittance to the multicast download group.

In response to the request message, the responding device may transmit an acknowledge message that causes the potential client device to become an active client (ACK:ACTIVE) or to become a passive client (ACK:PASSIVE). In response to the ACK:ACTIVE message the client device joins the multicast download group as an active client, 470, and operates as described above. In response to the ACK:PASSIVE message the client device joins the multicast download group as a passive client, 420, and operates as described above.

In one embodiment, once in the passive client state 420, the client remains a passive client until a currently active client completes download of the file and exits the multicast download group. When the multicast download group does not include an active client, one of the remaining passive clients is promoted to become the active client. In one embodiment, multiple passive clients may transmit requests to the server or other device in an attempt to be named the active client. The server or other device may select one of the passive clients to be the new active client. Alternatively, the server or other device may track the passive clients and proactively select one of the passive clients to become the new active client.

If a passive client meets the conditions set forth above to become a smart client, the passive client may become a smart client 450. The smart client may operate in the manner described above to request download of lost packets using a reliable, non-multicast protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request from a first client device to download a file to be transmitted as a plurality of packets of data from a server device;
multicasting the plurality of packets to multiple client devices including the first client device;
requesting, when the first client has completed download of the file, using a reliable protocol with a second client device from the multiple client devices packets not received by the second client device.

2. The method of claim 1 wherein the multicasting of the plurality of packets comprises multicasting to the multiple clients using a multicast Trivial File Transfer Protocol (TFTP).

3. The method of claim 1 wherein the reliable protocol comprises a Trivial File Transfer Protocol (TFTP).

4. The method of claim 1 wherein the download of the file occurs during a pre-boot phase of the first client device.

5. The method of claim 4 wherein the file comprises a boot image for the first client device.

6. The method of claim 1 wherein the second client device tracks packet gaps within the requested file and the size of the packet gaps during the multicast of the file.

7. A computer-readable medium having stored thereon instructions that, when executed, cause one or more processors to:
receive a request from a first client device to download a file to be transmitted as a plurality of packets of data from a server device;
multicast the plurality of packets to multiple client devices including the first client device;
request, when the first client has completed download of the file, using a reliable protocol with a second client device from the multiple client devices packets not received by the second client device.

8. The medium of claim 7 wherein the multicasting of the plurality of packets comprises multicasting to the multiple clients using a multicast Trivial File Transfer Protocol (TFTP).

9. The medium of claim 7 wherein the reliable protocol comprises a Trivial File Transfer Protocol (TFTP).

10. The medium of claim 7 wherein the download of the file occurs during a pre-boot phase of the first client device.

11. The medium of claim 10 wherein the file comprises a boot image for the first client device.

12. The medium of claim 7 wherein the second client device tracks packet gaps within the requested file and the size of the packet gaps during the multicast of the file.

13. A system comprising:
one or more processors;
a network interface coupled with the one or more processors; and
computer-readable medium coupled with the one or more processors having stored thereon instructions that, when executed, cause one or more processors to receive a request from a first client device to download a file to be transmitted as a plurality of packets of data from a server device, multicast the plurality of packets to multiple client devices including the first client device and request, when the first client has completed download of the file, using a reliable protocol with a second client device from the multiple client devices packets not received by the second client device.

14. The system of claim 13 wherein the multicasting of the plurality of packets comprises multicasting to the multiple clients using a multicast Trivial File Transfer Protocol (TFTP).

15. The system of claim 13 wherein the reliable protocol comprises a Trivial File Transfer Protocol (TFTP).

16. The system of claim 13 wherein the download of the file occurs during a pre-boot phase of the first client device.

17. The system of claim 10 wherein the file comprises a boot image for the first client device.

18. The system of claim 13 wherein the second client device tracks packet gaps within the requested file and the size of the packet gaps during the multicast of the file.
